(19) United States
(12) Patent Application Publication
(10) Pub. No.: US 2003/0090982 A1
(43) Pub. Date: May 15, 2003

(54) Optical disk drive assembly

(76) Inventors: Ying-Shuen Lee, Taipei (TW); Cheng-Fu Lee, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/127,131

(22) Filed: Apr. 22, 2002

(30) Foreign Application Priority Data
Nov. 13, 2001 (TW) 90219514

(51) Int. Cl. G11B 33/02

(52) U.S. Cl. 369/75.1

(57) ABSTRACT

An optical disk drive assembly. The optical disk drive assembly includes an assembly body and at least one attaching element. The attaching element supports the assembly body and includes a first portion attached to the assembly body, a second portion and a connecting portion connected between the first portion and the second portion.

### BACKGROUND OF THE INVENTION

1. Field of the Invention

The present invention relates to an optical disk drive assembly. In particular, the present invention relates to at least one attaching element for fixing the optical disk drive assembly to an object in different orientations.

2. Description of the Related Art

Compact disks (CDs) can store a large quantity of data and be carried conveniently due to their small size, so that they are popular and universal. Recently an external CD-ROM is a standard peripheral device for a portable computer. In contrast to the internal CD-ROM, the external CD-ROM consumes external power and is connected to the computer via data bus. The external CD-ROM is also suitable for a desktop computer. Generally, an external CD-ROM 1 is horizontally disposed on the top of a desktop computer 2 as shown in FIG. 1. However, such an arrangement is not always best, especially when the user has a lot of things to be arranged in limited space. Furthermore, the CD-ROM is not fixed on the desktop computer and therefore tends to be movable by accidental means.

### SUMMARY OF THE INVENTION

An object of the present invention is to provide an optical disk drive assembly (CD-ROM or DVD-ROM) that solves the above-mentioned problems.

The optical disk drive assembly of the present invention includes at least one attaching element and an assembly body fixed to a desktop computer via the attaching element. The attaching element includes a first portion attached to the assembly body, a second portion attached to the desktop computer and a connecting portion connected between the first portion and the second portion.

By the attaching element, the optical disk drive assembly can be fixed to a side surface of the desktop computer in a manner of vertical arrangement or inclined arrangement. Furthermore, the connecting portion of the attaching element is extended to stabilize the optical disk drive assembly when the optical disk drive assembly is disposed on uneven surfaces.

### BRIEF DESCRIPTION OF THE DRAWINGS

The present invention can be more fully understood by reading the subsequent detailed description and examples with references made to the accompanying drawings, wherein:

FIG. 1 depicts a conventional CD-ROM disposed on the top of a desktop computer;

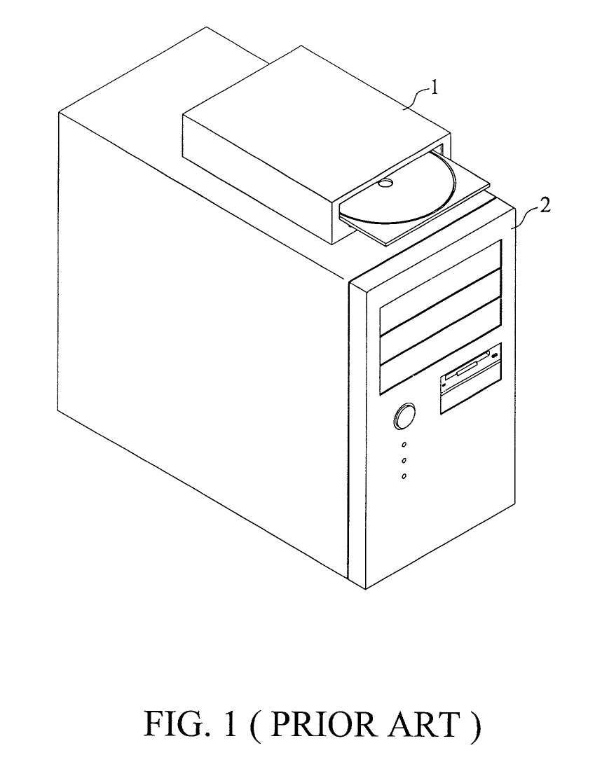

FIG. 2 is an exploded perspective diagram of an optical disk drive assembly in accordance with the present invention;

FIG. 3 depicts the optical disk drive assembly of the present invention attached to a side surface of a desktop computer, with the disk slot thereof facing the front;

FIG. 4 depicts the optical disk drive assembly of the present invention attached to a side surface of a desktop computer, with the disk slot thereof facing up at an inclined angle;

FIG. 5 depicts the optical disk drive assembly of the present invention attached to a side surface of a desktop computer, with the disk slot thereof facing up;

FIG. 6 depicts the optical disk drive assembly of the present invention disposed horizontally;

FIG. 7 depicts the optical disk drive assembly of the present invention disposed on a support object having a high horizontal surface and a low horizontal surface; and

FIG. 8 depicts the optical disk drive assembly of the present invention disposed on a support object having a horizontal surface and an inclined surface.

### DETAILED DESCRIPTION OF THE PREFERRED EMBODIMENT

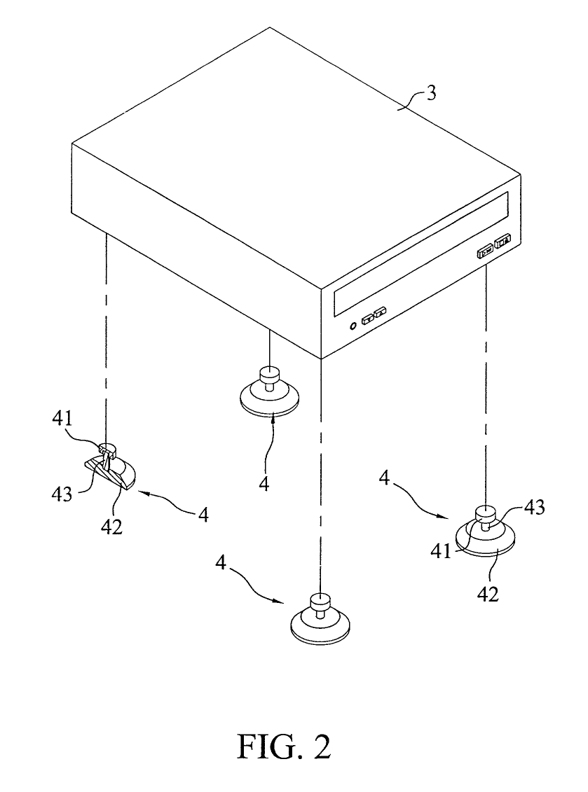

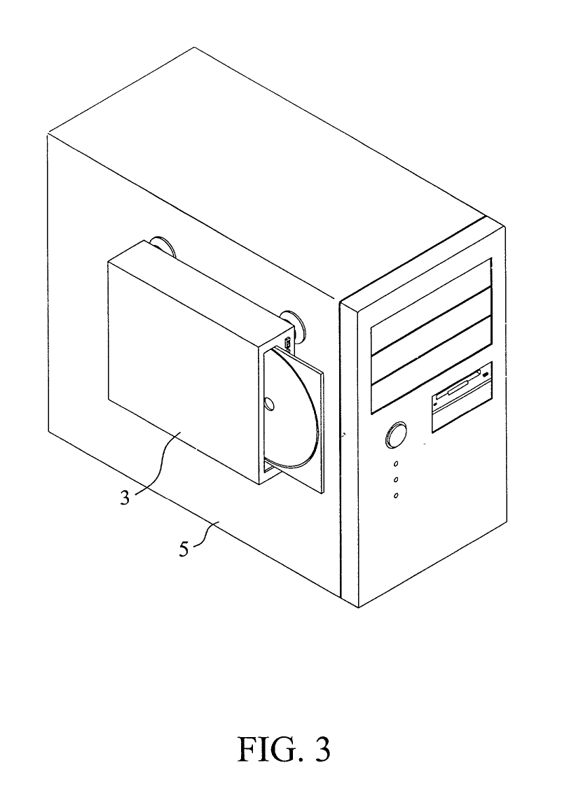

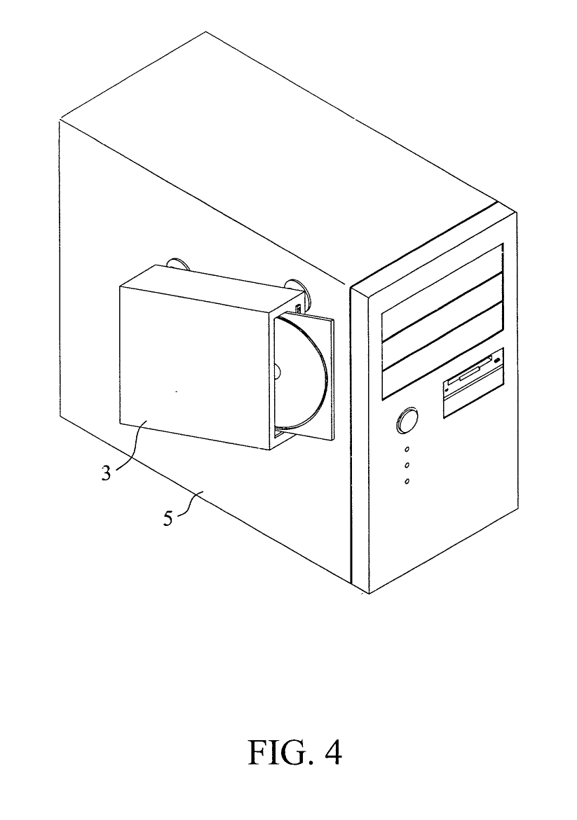

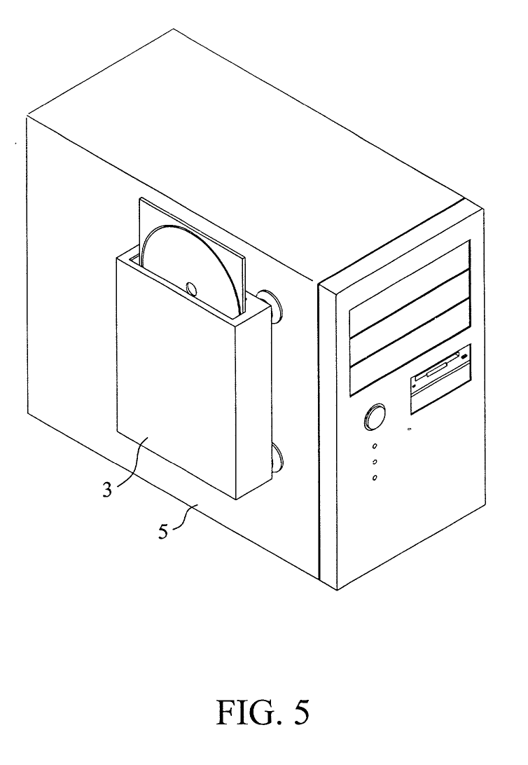

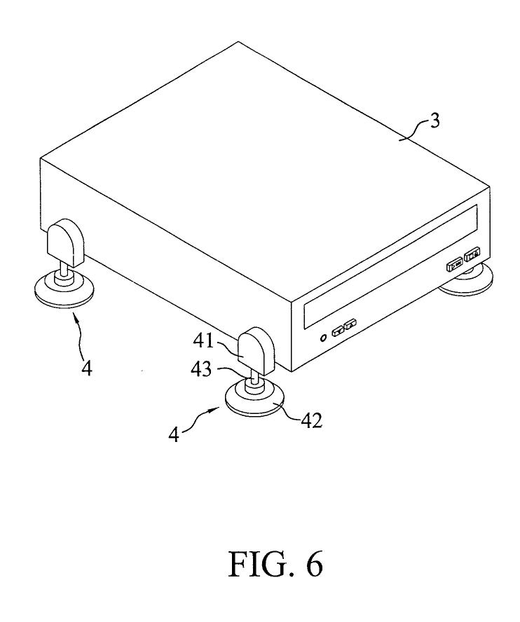

Referring to FIG. 2, an external optical disk drive assembly (e.g. CD-ROM, DVD-ROM etc.) of the present invention has an assembly body 3 and a plurality of attaching elements 4 mounted on the bottom of the assembly body 3. Each of the attaching elements 4 has a first portion 41 attached to the assembly body 3, a second portion 42 attached to an object 5 (FIGS. 3-5) and a connecting portion 43 (FIGS. 6-8) connected between the first portion 41 and the second portion 42. The connecting portion 43 is used for adjusting the distance between the first and second portions 41, 42. Furthermore, the connecting portion 43 is an extension rod or a threaded rod, while the first and second portions 41, 42 have holes or screw holes (not shown) for containing the connecting portion 43. The first and second portions 41, 42 are magnets or suction cups, fixing the assembly body 3 to the object 5. Alternately, the first and second portions 41, 42 are glued to the assembly body 3 of the optical disk drive assembly and the object 5.

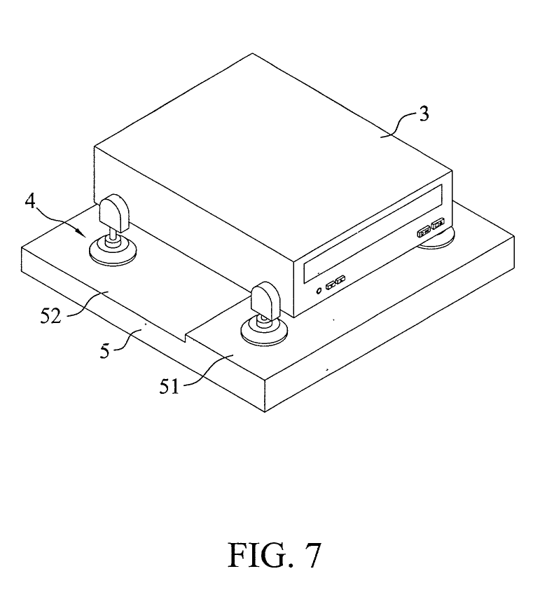

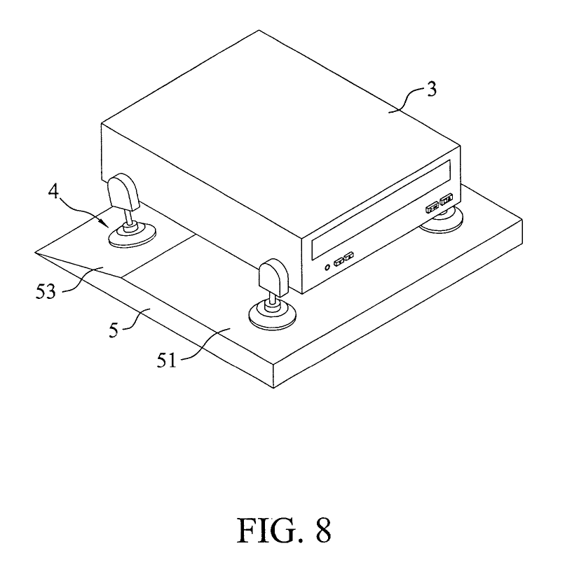

Referring to FIG. 6, the first portions 41 of the attaching elements 4 are rotatably connected to side surfaces of the assembly body 3 of the optical disk drive assembly. Referring to FIG. 7, the connecting portions 43 of the attaching elements 4 are extended to stabilize the assembly body 3 on the object 5 which has a high horizontal surface 51 and a low horizontal surface 52. Referring to FIG. 8, in a modified embodiment, the support object 5 has a horizontal surface 51 and an inclined surface 53. In the modified embodiment, the first portions 41 of the attaching elements 4 are oriented so that the second portions 42 can fully contact the inclined surface 53.

The present invention provides a plurality of attaching elements for fixing an optical disk drive assembly to an object. By the attaching elements, the optical disk drive assembly can be horizontally arranged on uneven surfaces or even be vertically arranged. Furthermore, the connecting portions of the attaching elements are extended to stabilize the displacement of the optical disk drive assembly. The machine vibrations are also effectively reduced.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical disk drive assembly, comprising:
an assembly body; and
at least one attaching element supporting the assembly body and including a first portion attached to the assembly body, a second portion and a connecting portion connected between the first portion and the second portion.

2. An optical disk drive assembly as claimed in claim 1, wherein the distance between the second portion and the first portion is adjustable via the connecting portion.

3. An optical disk drive assembly as claimed in claim 1, wherein the connecting portion is a threaded rod screwed to the first and second portions.

4. An optical disk drive assembly as claimed in claim 1, wherein the first and second portions are magnets.

5. An optical disk drive assembly as claimed in claim 1, wherein the first and second portions are vacuum cups.

6. An optical disk drive assembly as claimed in claim 1, wherein the first portion is a magnet, and the second portion is a vacuum cup.

7. An optical disk drive assembly as claimed in claim 1, wherein the first portion is a vacuum cup and the second portion is a magnet.
